(19) United States
(12) Patent Application Publication
(10) Pub. No.: US 2007/0121797 A1
(43) Pub. Date: May 31, 2007

(54) Automatic establishment of emergency call to PSAP via IP session

(75) Inventors: Stuart Owen Goldman, Scottsdale, AZ (US); Richard E. Krock, Naperville, IL (US); Karl F. Rauscher, Emmaus, PA (US); James Philip Runyon, Wheaton, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/287,734

(22) Filed: Nov. 28, 2005

(51) Int. Cl. H04M 11/04

(52) U.S. Cl. 379/37

(57) ABSTRACT

A method for reporting an emergency to a Public Safety Answering Point (PSAP) (200) is provided. The method includes: detecting for a condition indicative of an emergency; automatically initiating an interactive communication session (310) with the PSAP (200) over a network (300), the session (310) being initiated in response to detection of the condition; and, communicating at least one of a type of emergency and a location of the emergency to the PSAP (200) via the interactive session (310).

Field

The present inventive subject matter relates to the telecommunication arts. One particular application is found in conjunction with emergency telecommunication services (e.g., emergency 9-1-1 calls), and the specification makes particular reference thereto. However, it is to be appreciated that aspects of the present inventive subject matter are also amenable to other like applications.

### BACKGROUND

With reference to FIG. 1, as is known in the art, the Public Switched Telephone Network (PSTN) 10 includes mechanisms for directing certain calls, such as an emergency 9-1-1 call, to a Public Safety Answering Point (PSAP) 20. For example, consider an end office (EO) 30 serving a wireline or landline end user device (EUD) 40 (e.g., a telephone) from which a 9-1-1 call is placed. The EO 30 commonly includes a telecommunications switch 32 (e.g., a class 5 switch such as the Lucent Technologies 5ESS or another like switch) that is operatively connected, e.g., via a twisted-pair line or cable, to the EUD 40. When the switch 32 recognizes a 9-1-1 call, the call is routed, e.g., over the PSTN 10, to the PSAP 20 serving the geographic region in which the EUD 40 is located.

Typically, upon receiving a 9-1-1 call, the PSAP 20 queries an Automatic Line Identification (ALI) database (DB) using the telephone or directory number of the calling EUD 40. The ALI DB provides the PSAP 20 with information associated with the calling EUD 40, e.g., the geographic and/or physical location of the EUD 40 (i.e., a street address or other positional identification). In this manner, a proper response to the 9-1-1 call can be quickly and readily dispatched to the proper location or otherwise coordinated. In any event, however, the usual 9-1-1 call typically originates with an individual manually placing the call for assistance, and such an approach has certain limitations. For example, this approach is unsuitable when there is no individual available to place the emergency call.

Alternately, as shown in FIG. 2, an individual may subscribe to an emergency or alarm monitoring service provided by a third party, e.g., an alarm monitoring service provider (AMSP) 50. More specifically, alarm systems (AS) 52 are known to be used in both stationary applications (such as in a subscriber's home, office or other building 54) and mobile applications (such as in a subscriber's vehicle 56). The alarm system 52 detects any of a variety of conditions indicative of an emergency depending upon the application, e.g., fire, smoke, carbon monoxide, intrusion, airbag deployment, collision, theft, etc. Typically, when installed in a stationary location, the alarm system 52 is connected to the landline telephone service already provided to that location such that it has access to the PSTN 10, and when installed in a mobile application, the alarm system accesses the PSTN 10 via a conventional mobile or wireless telecommunications network 58. In either case, upon the tripping of an alarm or detecting a given condition, the alarm system 52 places a call over the PSTN 10 to the AMSP 50. Typically, the call from the alarm system 52 is received by the AMSP 50 where it is handled by an operator. The operator in turn takes one or more designated actions in response to the alarm and/or detected condition which is indicated by a signal transmitted from the alarm system 52 to the AMSP 50 over the connected call. Commonly, when circumstances warrant, the AMSP operator will then make an appropriate emergency call. For example, the AMSP operator may place an emergency 9-1-1 call over the PSTN 10 to the PSAP 20 on behalf of the subscriber or otherwise place an emergency call over the PSTN 10 directly to an emergency responder (ER) 60 (e.g., police, firefighters, emergency medical personnel, etc.). In any event, the actual emergency call to the PSAP 20 or the responder 60 still originates with an individual manually making the call.

While addressing the previously identified problem, conventional emergency or alarm monitoring services can still have certain limitations and/or drawbacks. For example, use of a monitoring service often involves an added layer of expense for the subscriber, who typically has to pay for the service. Moreover, the use of an AMSP 50 can result in an unwanted delay of the emergency call being placed to the PSAP 20. That is to say, the emergency call to the PSAP 20 is the second call placed, which is typically only placed by the AMSP operator after the AMSP 50 receives the first call from the alarm system 52. In emergency situations, even a slight delay (such as the delay experienced by having to place a second telephone call) can be significantly detrimental.

Additionally, with a conventional monitored alarm system, the PSAP 20 often has little or no ability to request or control the gathering of additional information directly from the scene of the emergency. Rather, the PSAP 20 is limited to receiving the information supplied by the AMSP operator since the 9-1-1 call is originating from the AMSP 50 and not the actual location of the emergency. Moreover, it may at times be beneficial for the PSAP 20 to interact directly with the scene of an emergency so as to assist in a resolution. Typically, a conventional monitored alarm system does not provide this functionality to the PSAP 20.

Accordingly, a new and improved method and/or system for automatically establishing emergency calls to a PSAP via an interactive Internet Protocol (IP) session or other like communication session is disclosed that overcomes the above-referenced problems and others.

### SUMMARY

In accordance with one embodiment, a method for reporting an emergency to a Public Safety Answering Point (PSAP) is provided. The method includes: detecting for a condition indicative of an emergency; automatically initiating an interactive communication session with the PSAP over a network, the session being initiated in response to detection of the condition; and,

communicating at least one of a type of emergency and a location of the emergency to the PSAP via the interactive session.

In accordance with another embodiment, a system for reporting an emergency to a PSAP includes: a sensor that detects for a condition indicative of an emergency; and, a unit that automatically initiates an interactive communication session with the PSAP over a network, the unit being operatively connected to the sensor to thereby monitor the sensor such that the session is initiated by the unit in response to detection of the condition by the sensor. Suitably, the unit communicates at least one of a type of emergency and a location of the emergency to the PSAP via the interactive session.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an example of a conventional telecommunications network for handling 9-1-1 calls.

FIG. 2 is a block diagram illustrating an example of a conventional configuration for a telecommunications network whereby an alarm monitoring service is provided by a third party to a subscriber.

FIG. 3 is a block diagram illustrating an exemplary configuration of an emergency monitoring system suitable for practicing aspects for the present inventive subject matter.

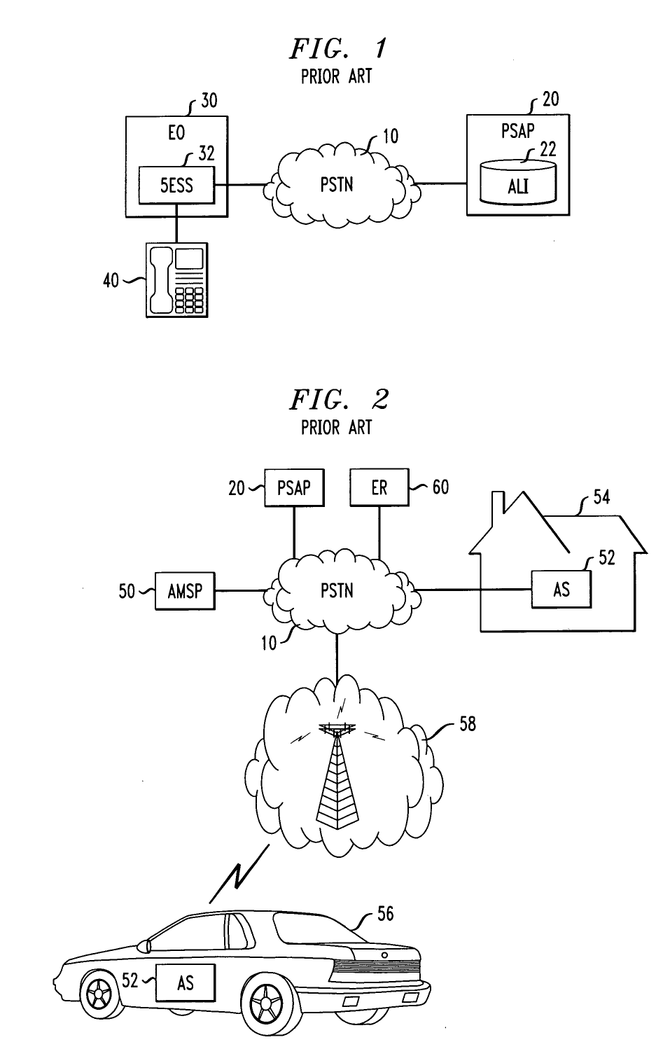

### DETAILED DESCRIPTION

As noted previously in the background section of the present specification, conventionally, calls for emergency assistance are usually directed to a PSAP directly from the person requesting aid, or through a third party that monitors an alarm system to determine if a detected condition or situation warrants a call for aid. In contrast, a suitable embodiment of the present inventive subject matter provides for direct notification to the PSAP whenever a detected condition or situation warrants such contact. Additionally, the PSAP is also optionally provided with the ability to perform additional operations to help determine the nature and/or extent of the emergency and/or to remotely assist in resolving the emergency. For clarity and simplicity, the present specification shall refer to structural and/or functional elements, entities and/or facilities, relevant communication standards, protocols and/or services, and other components and features that are commonly known in the telecommunications art without further detailed explanation as to their configuration or operation except to the extent they have been modified or altered in accordance with and/or to accommodate the embodiment(s) presented herein.

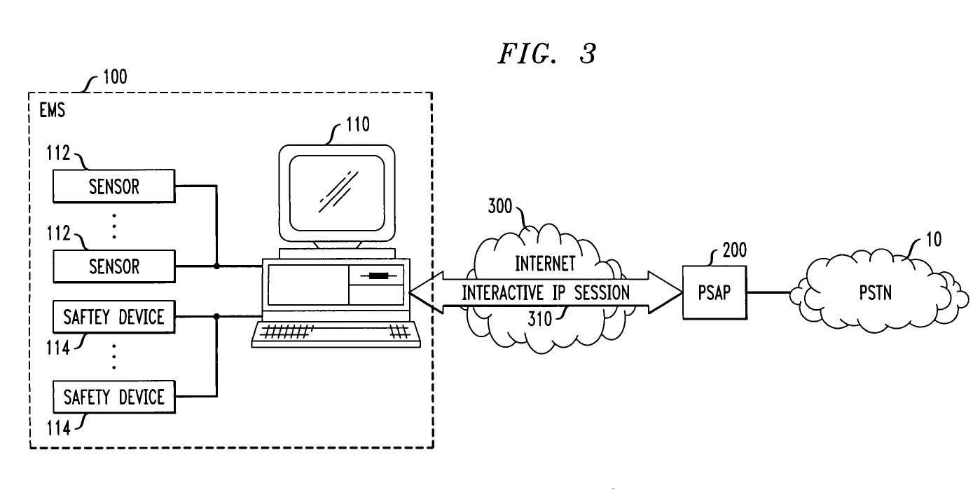

With reference to FIG. 3, an emergency monitoring system (EMS) 100 includes a primary unit 110 that is responsible for: monitoring one or more sensors 112; optionally controlling one or more safety devices 114; and, communicating with a PSAP 200 over the Internet 300 or another like packet-switched or IP network. As shown, the primary unit 110 is operatively connected to the sensors 112 which are suitably installed throughout a building, vehicle or other environment being monitored by the EMS 100. Suitably, the EMS 100 monitors for any number of different types of emergency situations, e.g., fire, intrusion, collision, theft, etc. Accordingly, the sensors 112 suitably detect one or more conditions indicative of the various emergency situations and communicate the detected conditions back to the primary unit 110 which is monitoring the sensors 112. For example, the sensors 112 may optionally detect: heat or smoke; the opening of a door or a window; motion or movement; the breaking of glass; carbon monoxide levels; airbag deployment or sudden impact; exhaust fumes; the running of an engine or motor; tampering with a lock or ignition; etc.

As shown, the primary unit 110 is also operatively connected to the safety devices 114 which are suitably installed throughout the monitored building, vehicle or other environment so as to be in a position to address emergency situations that may arise. Suitably, the primary unit 110 is able to control the safety devices 114 in response to directions received from the PSAP 200 thereby aiding in the resolution of an emergency situation. For example, the safety devices may optionally be one or more of the following: a sprinkler or fire suppression device; a window or door lock or automatic opening/closing device for the same; etc. Suitably, the primary unit 110 takes the form of a computer or other like device. The computer is optionally a general purpose computer provisioned to act as the primary unit 110 of the EMS 100 as well as performing other unrelated tasks. Alternately, the computer is a dedicated device solely tasked with operating as the primary unit 110 of the EMS 100.

In the illustrated embodiment, the primary unit 110 operatively connects to the Internet 300 in any customary manner. Likewise, in addition to its conventional interface to the PSTN 10, the PSAP 200 is also operatively connected to the Internet 300. Of course, while the network 300 shown in FIG. 3 is the Internet, it is to be appreciated the network 300 may in practice be any other suitable IP and/or packet-switched network to which both the primary unit 110 of the EMS 100 and the PSAP 200 have access.

In operation, the conditions detected by the sensors 112 are communicated to the primary unit 110 of the EMS 100. Based on the conditions indicated by the monitored sensors 112, the primary unit 110 of the EMS 100 determines if an emergency or other like situation exists which warrants contacting the PSAP 200. That is to say, the readings or detected conditions obtained from the sensors 112 are analyzed or otherwise evaluated by the primary unit 110 to determine if they are indicative of an emergency or other like situation, e.g., a fire, intrusion, collision, theft, medical emergency, etc. When an emergency is indicated or the determined situation otherwise warrants, the primary unit 110 of the EMS 100 automatically initiates an interactive IP-based or other like network session 310 directly with the PSAP 200 over the network 300. Optionally, to initiate the session 310 with the appropriate PSAP 200, the unit 110 is provisioned with a network address or the like for the PSAP 200. Alternately, the unit 110 may obtain the appropriate network address in any suitable manner.

To establish the session 310 over the network 300, a Session Initiation Protocol (SIP) invite or other like message is sent from the unit 110 to the PSAP 220 during the initiation and/or set-up of the session 310. Suitably, this SIP invite or other like message includes relevant data and/or information about the emergency, e.g., the location of the emergency (such as the address being monitored by the EMS 100); subscriber information (such as the name of the owner or user of the EMS 100); a phone number for the location being monitored; information about the nature of the emergency (such as the type of emergency, i.e., fire, intrusion, etc.); and/or any other relevant information that may be useful to the PSAP 200 in responding to the emergency. In this manner, the PSAP 200 is advised as to the nature and/or location of the emergency or other situation which triggered the unit 110 to establish the session 310.

Optionally, once the session 310 has been established, the PSAP 200 or an operator thereof may use the interactive session 310 to probe or query the EMS 100 for additional data that may be desired and/or relevant to the emergency. That is to say, the PSAP 200 optionally signals or otherwise directs the unit 110 via the established interactive session 310 to transmit or send back to the PSAP 200 (again via the session 310) one or more readings or measurements obtained by the unit 110 from the one or more sensors 112. Alternately, other data and/or information maintained by the unit 110 can similarly be retrieved by the PSAP 200 from the unit 110 using the interactive session 310 established over the network 300. That is to say, the unit 110 optionally maintains information and/or data indicating: how many and/or what types of safety devices the unit 110 has access to; which of the safety devices (if any) have been activated or what the states of the various safety devices 114 are; etc. Accordingly, by using the interactive session 310 to probe and/or query the unit 110, the PSAP 200 or PSAP operator may optionally obtain as desired any relevant information available from the EMS 100.

Suitably, the PSAP 200 or PSAP operator is also able to issue commands to and/or signal the unit 110 via the interactive network session 310 to thereby remotely control the safety devices 114 which are connected to and/or operated by the unit 110. In this way, the PSAP 200 is able to direct the unit's operation of the safety devices 114 in order to better aid resolution of the emergency.

As an example, in the case of a fire alarm, the PSAP 200 or PSAP operator could use the interactive session 310 to probe the unit 110 to determine if any sprinklers had been activated or if fumes or smoke had been or are still being detected. Then depending on the circumstances that triggered the fire alarm or the current situation, the PSAP 200 or the PSAP operator could issue appropriate remote commands via the session 310 to the unit 110 thereby remotely controlling one or more of the safety devices 114, e.g., so as to unlock selected doors, activate the sprinklers if they have not already been, close fire doors, etc. Additionally, in a suitable embodiment, the sensors 112 and/or safety devices 114 optionally include a video camera or other like device which (like the other sensors 112 and or safety devices 114) is monitored and/or operated by the unit 110. Accordingly, via the interactive session 310 between the PSAP and the unit 110, the PSAP 200 is optionally able to remotely control the camera and receive the video or pictures obtained therefrom. In this manner, the PSAP 200 is able to directly observe the environment monitored by the EMS 100 and therefore is better able to coordinate a response to any detected emergency.

Notably, via the interactive session 310 established between the PSAP 200 and the unit 110, the PSAP 200 is able to receive real-time data and/or information about the scene of an emergency which triggered the EMS 100. That is to say, the PSAP 200 is able to obtain information and/or data about a current state of an emergency which was initially detected at some earlier time. This can be a substantial benefit considering that in some instances the current state of an emergency may change from the time that it is first detected.

For example, a small fire may initially trigger an alarm. However, at or near the same time, sprinklers may be activated and the fire quickly extinguished. With a convention monitored alarm service, the AMSP only knows that the fire alarm was tripped and may not be aware that the fire is now extinguished. Accordingly, a response which is otherwise no longer appropriate may be forthcoming. For example, firefighters may be sent to the location even thought the fire is now out. Such a response in this instance is clearly wasteful. Moreover, as the AMSP typically has no way to monitor or control the scene in real-time, the sprinkler may be allowed to continue operating even after the fire has been put out, thereby causing otherwise avoidable water damage. On the contrary, with the present EMS 100, an interactive session 310 is established directly with the PSAP 200 over the network 300. Accordingly, the PSAP 200 is able to use the session 310 to probe and/or query the unit 110 in real-time to obtain or determine the current state of the emergency. Moreover, by sending appropriate commands and/or signals to the unit 110 via the session 310, the PSAP 200 is able to remotely react to the emergency in accordance with the current state of the emergency, for example, to shut off the sprinklers when the fire is extinguished thereby avoiding undue water damage.

Suitably, outside access to the unit 110 (e.g., via the network 300) is only permitted when the unit 110 has initiated the session 310. This restriction minimizes the possibility of intrusion by unauthorized parties and/or limits access to information on a general computer other than that which is relevant for analyzing and/or responding to the emergency. Additionally, the optional delivery of a telephone number in the SIP invite or other like message allows the PSAP 200 to place a call to the monitored location in an attempt to verify the condition or emergency reported by the EMS 100. Suitably, if there is no answer, the PSAP 200 can dispatch emergency responders to the site, the address of which is also identified in the session information.

As can be appreciated from the foregoing, the present inventive subject matter eliminates third party alarm monitoring services, and instead directs emergency assistance requests directly to the PSAP 200. This reduces the cost to the homeowner, business or other individual seeking this type of protection, but more importantly it also reduces the time it take to get emergency notification to the PSAP 200. One beneficial aspect is the ability of the local computer or primary unit 110 to initially identify itself, to report the emergency, and to open up the interactive session 310 with the PSAP 200. Other beneficial aspects include: the ability of the PSAP 200 to request collection of additional data; and, the ability of the PSAP 200 to remotely order the local computer or unit 110 to take additional steps to assist with resolution of the emergency. In short, the present approach can greatly reduce the time taken to contact the PSAP 200 with a request for assistance, and provide the PSAP 200 with the ability to make a more informed determination as to what type of help to dispatch, if any.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for reporting an emergency to a Public Safety Answering Point (PSAP), said method comprising:
(a) detecting for a condition indicative of an emergency;
(b) automatically initiating an interactive communication session with the PSAP over a network, said session being initiated in response to detection of the condition; and,
(c) communicating at least one of a type of emergency and a location of the emergency to the PSAP via the interactive session.

2. The method of claim 1, wherein the network is an Internet Protocol (IP) network.

3. The method of claim 2, wherein a sensor is used for the detecting.

4. The method of claim 3, wherein the sensor detects at least one of heat, smoke, fire, motion, carbon monoxide, collision, glass break, intrusion or theft.

5. The method of claim 3, further comprising:
monitoring the sensor with a unit that initiates the interactive session with the PSAP.

6. The method of claim 5, wherein the unit is a computer that determines if the condition detected by the sensor is indicative of the emergency.

7. The method of claim 6, wherein the computer is provisioned with the network address of the PSAP.

8. The method of claim 5, further comprising:
probing the unit from the PSAP via the interactive session to obtain additional information about the emergency.

9. The method of claim 5, wherein the unit is operatively connected with a safety device so as to be able to control the safety device.

10. The method of claim 9, further comprising:
sending the unit a signal from the PSAP via the interactive session so as to direct operation of the safety device by the unit.

11. The method of claim 9, wherein the safety device is at least one of the following: a sprinkler, a fire suppression device, a door or window locking device, or a door or window opening or closing device.

12. The method of claim 1, wherein step (c) comprises sending a Session Initiation Protocol (SIP) invite message to the PSAP during establishment of the session, said invite message including the communicated information.

13. A system for reporting an emergency to a Public Safety Answering Point (PSAP), said system comprising:
a sensor that detects for a condition indicative of an emergency;
a unit that automatically initiates an interactive communication session with the PSAP over a network, said unit being operatively connected to the sensor to thereby monitor the sensor such that the session is initiated by the unit in response to detection of the condition by the sensor; and,
wherein the unit communicates at least one of a type of emergency and a location of the emergency to the PSAP via the interactive session.

14. The system of claim 13, wherein the sensor detects at least one of heat, smoke, fire, motion, carbon monoxide, collision, glass break, intrusion or theft.

15. The system of claim 13, wherein the unit is a computer that determines if the condition detected by the sensor is indicative of the emergency.

16. The system of claim 15, wherein the computer is provisioned with the network address of the PSAP.

17. The system of claim 13, wherein the interactive session established between the unit and the PSAP allows the PSAP to probe the unit to obtain additional information about the emergency.

18. The method of claim 13, wherein the unit is operatively connected with a safety device so as to be able to control the safety device.

19. The method of claim 18, wherein the interactive session established between the unit and the PSAP allows the PSAP to send the unit a signal via the interactive session so as to direct operation of the safety device by the unit.

20. The method of claim 19, wherein the safety device is at least one of the following: a sprinkler, a fire suppression device, a door or window locking device, or a door or window opening or closing device.
